(19) United States
(12) Patent Application Publication
(10) Pub. No.: US 2026/0283178 A1
(43) Pub. Date: Sep. 24, 2026

(54) PROCESS FOR MAKING A CHEESE

(71) Applicants: EURIAL, NANTES (FR); CENTRE NATIONAL DE LA RECHERCHE SCIENTIFIQUE, Paris (FR); INSTITUT POLYTECHNIQUE DE BORDEAUX, Talence (FR); UNIVERSITE DE BORDEAUX, Bordeaux (FR)

(72) Inventors: Gilles AUGELET, Cissé (FR); Arnaud RICHER DE FORGES, Fontaine le Comte (FR); Manon BASSET, Seyresse (FR); Laurent NOËL, Nantes (FR); Christelle HARSCOAT-SCHIAVO, Langon (FR); Raphaêlle SAVOIRE, Begles (FR); Fernando LEAL-CALDERON, La Brede (FR)

(73) Assignees: EURIAL, Nantes (FR); CENTRE NATIONAL DE LA RECHERCHE SCIENTIFIQUE, Paris (FR); INSTITUT POLYTECHNIQUE DE BORDEAUX, Talence (FR); UNIVERSITE DE BORDEAUX, Bordeaux (FR)

(21) Appl. No.: 19/474,116

(22) PCT Filed: Apr. 12, 2024
(86) PCT No.: PCT/FR2024/050484

§ 371 Date: Oct. 9, 2025

(30) Foreign Application Priority Data
Apr. 12, 2023 (FR) FR2303629
Apr. 12, 2023 (FR) FR2303631

(51) Int. Cl. A23C 19/068; A23C 9/142; A23C 19/064; B01D 63/08; B01D 63/10; B01D 69/02

(52) U.S. Cl. CPC A23C 19/0682; A23C 9/1422; A23C 19/064; B01D 63/08; B01D 63/10; B01D 69/02; A23C 2210/206; B01D 2325/34

(57) ABSTRACT

A method for manufacturing a fresh or ripened cheese from a cheese-making dairy mixture containing, on the one hand, one or several dairy fractions selected from the retentates of a microfiltration of a pasteurized skimmed milk, the retentates of an ultrafiltration of a whole milk or a pasteurized skimmed milk and the retentates of an ultrafiltration of a microfiltration permeate of a pasteurized skimmed milk, and on the other hand cream. The method being characterized in that: all or part of the curd is heat-treated, and the heated curd is drained by at least one ultrafiltration and then homogenized.

The invention belongs to the field of the dairy industry and relates to the manufacture of a fresh or ripened cheese. More precisely, it concerns a method for draining a milk mixture after its maturation in order to increase its draining capacity and, more generally, to give the curd thus drained a cheese-making aptitude identical or even improved compared to a cheese manufactured by conventional methods.

By cheese according to the invention, it should be understood any dairy product resulting from the maturation of milk. More specifically, reference will be made to cow's, goat's or sheep's milk, as well as any mixture of these milks, without the invention being restricted thereto. It may indeed be envisaged that the method could be applied to obtain a cheese from buffalo's milk.

According to a conventional method, the process for manufacturing a cheese comprises the following steps:
pasteurization of the collected milk to obtain pasteurized milk;
optionally, total or partial skimming of the pasteurized milk to collect the pasteurized and skimmed milk, on the one hand, and the cream, on the other hand;
ultrafiltration of the skimmed milk and recovery of an ultrafiltration retentate and an ultrafiltration permeate, respectively;
heat treatment (or heating) of the ultrafiltration retentate and heat treatment (or heating) of the cream;
combination of all or part of the heated ultrafiltration retentate and all or part of the heated cream to obtain a standardized dairy mixture;
optionally, homogenization of the standardized dairy mixture;
maturation;
draining;
salting, molding or molding, salting; and
optionally, ripening.

Before discussing the presentation of the invention, some of the terms used in the text are defined.

By raw milk it should be understood the milk directly obtained from milking of the animal. By whole milk as used in cheese-making it should be understood a milk which has the same composition as the raw milk from which it is derived, in particular the same fat content, but which results from at least partial skimming after which it is mixed with at least one part of the cream resulting from the skimming, generally in order to obtain a determined fat content. According to the method of the invention, the starting milk is raw milk or whole milk.

Milk comprises two main types of protein: caseins, mainly in the form of micelles, and lactoserum proteins, which are water-soluble and small-sized, also called whey proteins. Caseins and whey proteins have very different properties, the former being thermally stable but coagulate at acidic pH, the latter being heat-sensitive; heating leading to their denaturation, forming aggregates that are more or less soluble depending on their size.

In dairy technology, whey proteins are distinguished according to physical treatment(s) applied thereto; whey proteins of milk are called native; when the milk is subjected to a microfiltration, they are recovered in the permeate; a heat treatment of the latter leads to their denaturation; we speak of denatured native whey proteins; the whey proteins present in the whey resulting from the draining of the curd are called, at this stage, whey proteins; when subjected to heat treatment, they become insoluble; and are known as denatured whey proteins (DWP).

The standardization of milk or a dairy fraction is a step in cheese-making which consists in adjusting the composition of the milk or the dairy fraction, in particular in terms of fat, protein, possibly denatured native whey proteins, and/or possibly denatured whey proteins (DWP); it is generally carried out by adding a dairy fraction such as a cream, a filtration retentate or permeate (microfiltration, ultrafiltration) until the desired contents are reached.

In a milk mixture or dairy mixture, we include, in addition to the milk mixtures resulting from the application of various physical treatments such as filtration, heat treatment, standardization, homogenization, and which are specified at each step concerned, milk mixtures which may or may not have different collection and animal origins.

A cheese-making dairy mixture is a mixture of dairy fractions that have been treated, separately or as a mixture, to transform the original milk(s) into a product that can be directly curdled for the manufacture of a cheese, and which has cheese-making properties superior to those of the original milk(s). By cheese-making properties it should be understood the ability of a curd to drain, then be shaped and develop all the desired organoleptic qualities while achieving high material yield performance. The more effective the draining, the less water the curd contains and the longer the cheese can be preserved and the more suitable it is for ripening.

During a filtration treatment, the fraction that passes through the filtration membrane is called permeate, and the fraction that is retained on the filtration membrane is called retentate.

By maturation of a milk or dairy mixture, also called curdling or coagulation, it should be understood the step of solidifying said milk mixture, by lactic means, naturally or with the addition of ferments, resulting from the production of lactic acid from lactose by lactic bacteria present in the milk or added to the mixture, or by enzymatic means with the addition of a coagulating solution, such as rennet, to the mixture. In the dairy industry, it is more commonly achieved by combining the two means, we speak of mixed coagulation. The maturation step is carried out at a temperature of 20-45° C. During this treatment, the caseins are coagulated forming the curd.

Draining is the step during which the curd is freed from part of its uncoagulated fraction, namely its lactoserum (or whey). This is a key step in the manufacture of a cheese, as it guarantees quality and preservation. In particular, it determines the quantity of residual lactoserum, which directly impacts the functional and organoleptic properties of the cheese. This step can implement different technologies depending on the nature of the curd to be drained. In lactic technology, which involves mixed coagulation (enzymatic and acid), this draining is conventionally performed by simply draining the lactoserum on a cloth or Berge filter, by tangential filtration such as, for example, ultrafiltration, but also by other modes such as centrifugation. These various modes can be combined with a heat treatment occurring before or after the draining step.

However, these techniques have drawbacks.

Draining with a Berge filter poses the following problems:
interruption of the manufacturing method as long as the draining operation of the curd is not complete;
difficult and costly automation of the draining step and more or less precise control of the desired draining level of the curd;
heterogeneity of the draining level within the cheese matrix;
significant material losses in the lactoserum;
the need for multiple draining equipment and the large, occupied floor space required depending on the desired production capacity;
long cleaning time and high consumption of chemicals and water for cleaning the draining equipment;
high maintenance costs for the upkeep of the draining equipment.

Whatever the draining technique used, a maximum dry matter is obtained which is limited and insufficient for a certain range of cheeses intended for ripening, it is generally less than 38% dry matter (DM) relative to the cheese (w/w) for a ratio of fat (F) to dry matter, F/DM, ranging from 45 to 55%.

By combining both a specific treatment of the milk before its curdling and a particular draining of the curd, the invention provides a solution to most of the aforementioned problems.

Thus, the invention concerns a method for manufacturing a fresh or ripened cheese from a cheese-making dairy mixture containing, on the one hand, one or several dairy fractions selected from the retentates of a microfiltration of a pasteurized skimmed milk, the retentates of an ultrafiltration of a whole milk or a pasteurized skimmed milk, and the retentates of an ultrafiltration of a microfiltration permeate of a pasteurized skimmed milk, and on the other hand cream, said method comprising the following steps:
(I) preparation of the cheese-making dairy mixture by
   (Ii) heat treatment of the dairy fraction(s) and cream, respectively, at a temperature of 65-120° C., for 30-900 seconds;
   (Iii) mixing of the heat-treated dairy fraction(s) and cream to obtain the dairy mixture; and
   (Iiii) standardization of said dairy mixture by adjusting the protein content of the heated mixture to 3-10% (w/w) relative to the mixture and adjusting the fat content of the heated mixture to 3-10% (w/w) relative to the mixture to obtain said cheese-making dairy mixture; or
   (Ii′) mixing of the dairy fraction(s) and cream to obtain the dairy mixture;
   (Iii′) heat treatment of the dairy mixture, at a temperature of 65-120° C., for 30-900 seconds; and
   (Iiii′) standardization of the dairy mixture by adjusting the protein content of the mixture to 3-10% (w/w) relative to the mixture and adjusting the fat content of the mixture to 3-10% (w/w) relative to the mixture to obtain said cheese-making dairy mixture;
(II) maturation (or curdling) of the cheese-making dairy mixture to obtain a curd;
(III) draining of the curd;
(IV) cooling of the drained curd;
(V) salting and molding, or molding and salting; and
(VI) optionally ripening,
a method in which, after step (II), all or part of the curd is heat-treated and in which, in step (III) said heated curd is drained by at least one ultrafiltration and then homogenized.

Homogenization is essential, it can be performed by a technology selected from high pressure, for example at a pressure of 5-800 bars, or shear phenomena applied to the mixture to be homogenized.

Part or all of the curd resulting from step (II) and before its draining by ultrafiltration (III), is heat-treated, preferably at a temperature of 25 to 60° C., for a few seconds to 600 seconds. This optional step corresponds to a reheating of the curd intended to optimize draining performance.

Advantageously, the draining of the heated curd fraction is performed by two consecutive ultrafiltrations.

According to one variant, the entire curd is heat-treated (or reheated) and then drained by at least one ultrafiltration, preferably two ultrafiltrations.

In preferred embodiments, the ultrafiltration step(s) meets the following characteristics which can be considered alone or indifferently combined with each other.

The ultrafiltration membrane is a ceramic or organic membrane, preferably an organic membrane and even better a combination of at least one organic spiral membrane and at least one organic flat membrane.

Advantageously, the ultrafiltration(s) of the curd is/are performed at the spiral membrane with a pressure of approximately 1.5-3 bars at the inlet and 1-2 bars at the outlet, and at the flat membrane with a pressure of approximately 5 to 10 bars at the inlet and 0.5 to 2 bars at the outlet.

At least one or all of the filtration membranes have a weight cut-off (MWCO) of 10-50 kDa, and preferably 10-20 kDa.

According to one variant, the standardization of the dairy mixture (Iiii) or (Iiii′) may further comprise an adjustment of the content of heat-treated native whey proteins by 0-20% (w/w) relative to the total protein content of said standardized milk.

The method of the invention may comprise other intermediate steps of homogenization of the dairy mixture during treatment. Thus, one or several homogenizations may be provided during the step of preparing the cheese-making dairy mixture (I), in particular after any one of the sub-steps (Ii), (Iii), (Iiii), (Ii′), (Iii′), (Iiii′). The homogenization may be performed by a technology selected from high pressure, for example at a pressure of 5-800 bars, or shear phenomena applied to the mixture to be homogenized.

In an embodiment where not all of the curd is heat-treated and subjected to one or several ultrafiltrations, the method of the invention may further comprise a step of draining the other part of the curd not subjected to heating and ultrafiltration, which may be carried out by a conventional technique, for example on a Berge filter. At the end, this part of the curd thus drained, or retentate, and the permeate may be recovered.

The conventionally drained part of the curd and the ultrafiltration-drained curd are cooled and are advantageously brought together before molding or salting. This variant does not significantly impair the cheese-making aptitude of the curd thus obtained. Under these conditions, the permeate of the conventionally drained curd is recovered, it can be subjected to an ultrafiltration and the resulting filtrate which contains the whey proteins can be subjected to a heat treatment to obtain denatured whey proteins (DWP) which are advantageously recycled upstream of the method during the standardization (Iiii) or (Iiii′) of the dairy mixture in step (I) of preparing the cheese-making dairy mixture.

According one a variant, cooling of the curd in step (IV) is carried out by lowering the temperature to a value of 0-30° C.

The interest of the method of the invention is reinforced if it is combined with a particular method for obtaining the cheese-making dairy mixture. While improving the draining performance, obtaining a cheese-making dairy mixture as described below leads to a standardized milk, ideally suited to the type of cheese to be manufactured.

Thus, said mixture is obtained from cow's, goat's or sheep's milk, but also from other mammals, and from any mixture of these milks. Preferably, according to the invention, it is goat's milk, optionally mixed with cow's milk. Thus, the method of the invention may further comprise the following steps:
a) pasteurization of the raw milk;
(b) skimming of the pasteurized whole milk and recovery of the skimmed milk, on the one hand, and cream, on the other hand;
c) microfiltration of the skimmed milk and recovery of the microfiltration retentate;
the microfiltration retentate recovered in step c) being a dairy fraction intended to be mixed with the cream recovered in step b) for the preparation of said cheese-making dairy mixture prepared in step (I).

According to a preferred variant of the invention, the skimming c) of the whole milk is maximal, or even total.

Microfiltration c) will allow the passage through the filtration membrane of a part of the soluble proteins, and the retention by this membrane of macromolecules, namely casein micelles, residual fat and any bacteria present.

In a particular implementation of the method, the microfiltration of the skimmed milk c) is carried out on a microfiltration membrane whose average pore diameter is 0.1-10 μm and preferably 0.1-3 μm. The microfiltration membrane may be a ceramic membrane or an organic membrane, preferably it is a ceramic membrane and even better a ceramic membrane with a permeability gradient (GP).

The microfiltration of the skimmed milk c) is, according to a particular embodiment, performed by applying a pressure difference of 1-2 bars between the inlet and the outlet of the microfiltration membrane, preferably 1.5-2 bars. Advantageously the pressure at the inlet is 2-4 bars and the pressure at the outlet is 0.5-2 bars.

After microfiltration of the skimmed milk c) according to the above variant, the microfiltration retentate constituting a dairy fraction and the cream intended for the preparation of the cheese-making dairy mixture (I) are subjected to a heat treatment (Ii), separately, or (Iii′) mixed beforehand. It can be carried out at a temperature of 65-120° C., advantageously 80-95° C., for 30-900 seconds, advantageously for 50-600 seconds.

According to one variant, the above method may be supplemented by the following steps:
d) recovery of the microfiltration permeate from step c), ultrafiltration of said permeate and recovery of the ultrafiltration retentate,
e) heat treatment of all or part of said ultrafiltration retentate at a temperature of 65-100° C. for 30-900 seconds, and
f) mixing of the heated ultrafiltration retentate with the mixture from step Iii) or the mixture from step Iii′) in steps Iiii) and Iiii′), respectively, to obtain a cheese-making dairy mixture.

Ultrafiltration makes it possible to retain and concentrate, in the retentate, native whey proteins which are present in the permeate resulting from the microfiltration of the skimmed milk.

In this variant, it is advantageous for the soluble protein content in the ultrafiltration retentate recovered in step d) to be 0-10.0% (w/w) relative to the initial soluble protein content of the microfiltered skimmed milk from step c), preferably 0.3 to 0.6%, regardless of the time of year.

In step e) of this variant, the heat treatment of the ultrafiltration retentate is preferably carried out at a temperature of 78-90° C., for 50-600 s.

Optionally but preferably, it is provided that, after step e) and before step f), the heated ultrafiltration retentate is homogenized.

It may also be provided that the method comprises a step of recovering at least one part of said ultrafiltration retentate f) then a step of drying said ultrafiltration retentate thus recovered for use in human food or complementary feeding.

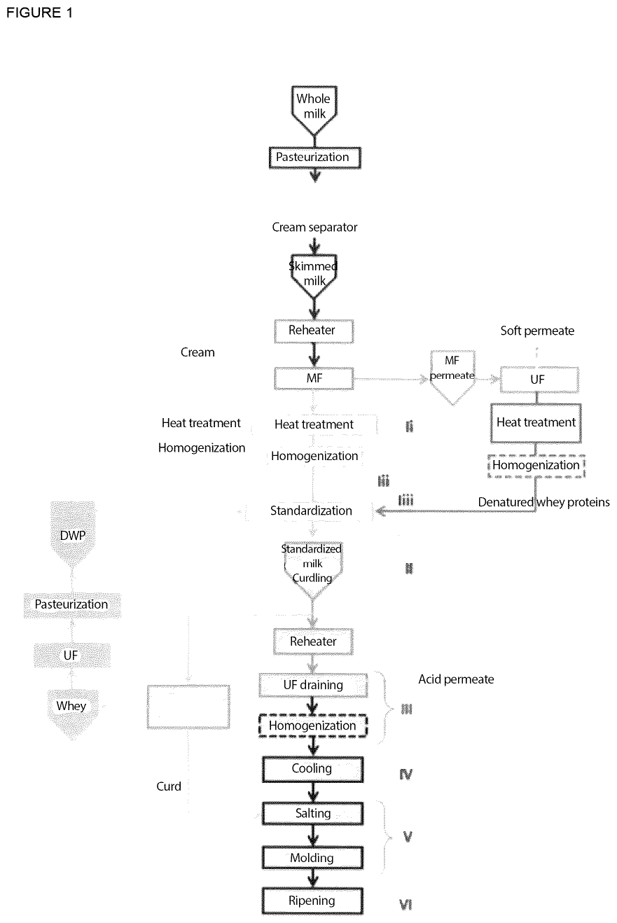

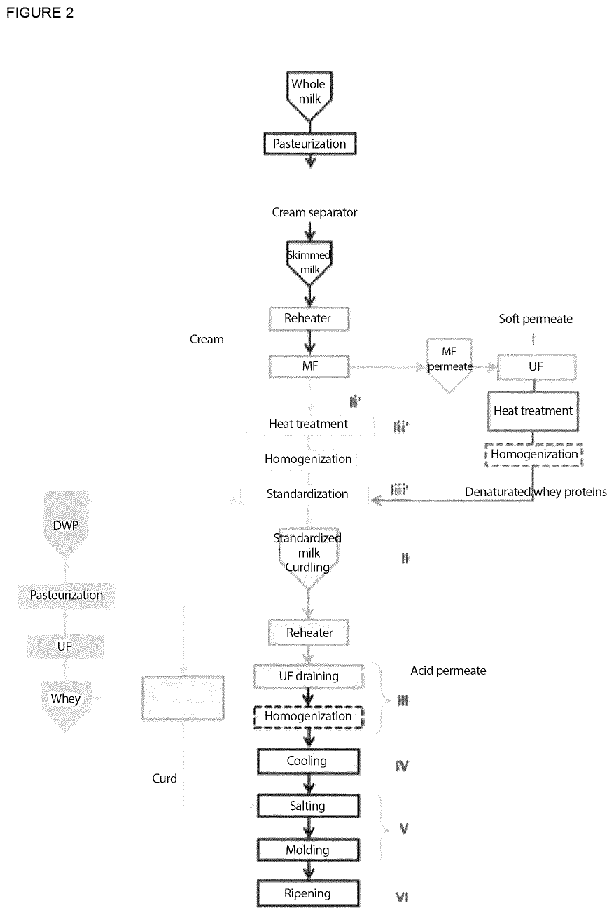

A method of the invention is described in more detail in support of FIGS. 1 and 2 which are diagrams representing an implementation of a method of the invention from step a) of pasteurization of the milk to step VI of obtaining a ripened cheese, a ripened goat cheese log, illustrating some preferred variants with the addition of steps considered as optional, but contributing to obtaining a cheese which has the desired properties.

In these figures, raw milk or whole goat's milk is pasteurized and subjected to skimming in a cream separator, for example by centrifugation. Skimming can be carried out on cold or hot milk. It can even be performed during pasteurization, for example in a centrifugal separator, as is commonly practiced in the dairy industry. Any additional treatment of raw milk, or even pasteurized milk, making it possible to optimize skimming can be undertaken, such as clarification in a clarifier. Advantageously, a skimmed milk with a fat content of 0.05-0.1% (w/w) is obtained.

Before being subjected to a microfiltration according to the method of the invention intended to separate the protein fractions and more precisely to retain the casein micelles in the retentate, the permeate now containing only the small-sized whey proteins, the skimmed milk is preferably heated to a temperature in the range of 50° C. in order to optimize the microfiltration efficiency.

Microfiltration (MF) is performed on a 4.56 m² membrane module equipped with a ceramic membrane marketed under the brand name Membralox® P1940 GP with a pore diameter of 0.1 μm. The supply flow rate is 400 l/h and the pressure at the inlet of the GP ceramic membrane module is approximately 3 bars and 1 bar at the outlet. The volume reduction factor or concentration factor (VRF) applied to the skimmed milk during the microfiltration step is approximately 2.2. The VRF is defined as the ratio of the initial volume of skimmed milk (to be treated) to the volume of the retentate, at a given time.

The stages (Ii)-(Iiii) of step (I) of the method of the invention are illustrated in FIG. 1. Thus, the microfiltration retentate is heated to a temperature of 65-120° C. for a duration of 30-900 seconds. For example, the heating is carried out at 75° C. for 60 seconds. As provided for in a preferred variant of the method of the invention, the microfiltration retentate Iii) is then homogenized. This step aims to disperse the fat particles in order to give the mixture a homogeneous texture. The homogenization is performed under high pressure of 60 bars. Then the cream is added for the standardization step (Iiii).

The stages (Ii′)-(Iiii′) of step (I) of the method of the invention are illustrated in FIG. 2. Thus, the microfiltration retentate and the cream are mixed and then the mixture is heated to a temperature of 65-120° C. for a duration of 30-900 seconds. For example, the heating is carried out at 75° C. for 60 seconds. As provided for in a preferred variant of the method of the invention, the mixture of the microfiltration retentate and cream Iii′) is then homogenized. This step aims to disperse the fat particles in order to give the mixture a homogeneous texture. The homogenization is performed under high pressure of 60 bars.

In a particular exposed implementation of the method described above, the microfiltration permeate containing the above small-sized whey proteins (4-5 g/l of native whey proteins) is recovered and is cold-concentrated by ultrafiltration (UF) (VRF of approximately 6) on a Dairy-Pro® organic spiral ultrafiltration membrane module (Koch Membrane Systems) having a weight cut-off of 20 kDa. This ultrafiltration retentate is subsequently heated according to step e) to a temperature of 80° C. for 300 seconds. Before being mixed with the mixture Iii′, the heated ultrafiltration retentate is homogenized; the homogenization is performed under high pressure of 20 bars. It is then mixed according to step f) with the homogenized mixture of the microfiltration retentate and cream Iii′). The mixture thus obtained has the following composition: dry matter (DM) of 13-25% (m/m), a fat (F) content of 3-10% (m/m) corresponding to 50 to 120% of the fat of whole milk, and a ratio of fat (F) to protein (P), F/P ranging from 0.4-1.35.

The cheese-making dairy mixture thus obtained at the end of step I is left to curdle according to step II, for 18 hours at 26° C. until it reaches a pH of 4.75.

In the illustrated method, the resulting curd is subjected to draining by two ultrafiltrations (UF) (combined under step III). In order to optimize the draining efficiency, the curd is first heated to a temperature of 45° C., before the ultrafiltration step. The first ultrafiltration is carried out on an organic spiral membrane module marketed under the brand name SYNDER® MQ 5 B 3838 of 3.53 m² equipped with membranes with a weight cut-off of 50 kDa. The retentate of this first ultrafiltration is then ultrafiltered on a 2.25 m² organic flat membrane module marketed under the brand name NADIR® PM UH050 M37N equipped with membranes with a weight cut-off of 50 kDa. The supply flow rate of the equipment is 400 l/h and the product recirculation flow rate at the flat membranes is approximately 15,000 l/h with an inlet pressure of 6 bars and an outlet pressure of 1.5 bar. The volume reduction factor (VRF) applied to the milk during the ultrafiltration step is approximately 2.

The curd thus drained has a dry matter of approximately 38-40% (m/m).

It is homogenized under high pressure of 100 bars. It is then cooled (step IV) to 10° C., then salted and molded (step V) and ripened (step VI) under the usual conditions for the manufacture of goat milk logs.

As provided for in a variant of the method of the invention described above, a part of the curd resulting from step (II) is not drained by ultrafiltration but is drained by a conventional method, for example on a Berge filter. The curds drained, respectively by ultrafiltration and on a Berge filter, are mixed at the time of salting, then together molded and ripened.

In an optional additional step, the permeate from the filtration on Berge filter is subjected to an ultrafiltration and then heated to a pasteurization temperature to be then recycled upstream of the method in step I of preparing the cheese-making dairy mixture in step Iiii′). This concentrated and heat-treated permeate mainly contains denatured whey proteins (DWP).

The cheese thus manufactured has the following characteristics:
its composition is perfectly controlled (regularity) in terms of dry matter and fat (F)/dry; the method according to the invention makes it possible to obtain a cheese with a high dry matter rate exceeding 40% and which can reach 45%, with a F/DM ratio of 45 to 55%;
its texture is firm, fine and melts in the mouth;
it gradually ripens over time, developing characteristic aromas;
its shelf life is suitable for all distribution networks;

It is suitable for various types of use, on a platter, in cooking or for snacking, either hot (oven, griddle . . . ) or cold.

1.-21. (canceled)

22. A method for manufacturing a fresh or ripened cheese from a cheese-making dairy mixture, wherein
the cheese-making dairy mixture contains:
on the one hand, one or several dairy fractions selected from the retentates of a microfiltration of a pasteurized skimmed milk, the retentates of an ultrafiltration of a whole milk or of a pasteurized skimmed milk or the retentates of an ultrafiltration of a microfiltration permeate of a pasteurized skimmed milk, and
on the other hand cream,
and wherein the method comprises the following steps:
(I) preparing the cheese-making dairy mixture by
(Ii) heat treating the dairy fraction(s) and cream, respectively, at a temperature of 65-120° C., for 30-900 seconds;
(Iii) mixing heat-treated dairy fraction(s) and heat-treated cream to obtain a dairy mixture; and
(Iiii) standardizing the heated dairy mixture by adjusting protein content of the mixture to 3-10% (w/w) relative to the mixture and adjusting fat content of the mixture to 3-10% (w/w) relative to the mixture to obtain the cheese-making dairy mixture; or
(Ii′) mixing of the dairy fraction(s) and cream to obtain a dairy mixture;
(Iii′) heat treating the dairy mixture at a temperature of 65-120° C., for 30-900 seconds; and
(Iiii′) standardizing the heated dairy mixture by adjusting protein content of the mixture to 3-10% (w/w) relative to the mixture and adjusting fat content of the mixture to 3-10% (w/w) relative to the mixture to obtain a standardized dairy mixture to obtain the cheese-making dairy mixture;
(II) curdling the cheese-making dairy mixture obtained after step (I) to obtain a curd;
after step (II), before step (III), heat-treating all or part of the curd;
(III) draining the curd by at least one ultrafiltration and then homogenizing;
(IV) cooling the drained curd;
(V) salting and molding, or molding and salting; and
(VI) optionally ripening.

23. The method according to claim 22, comprising draining heated curd by two consecutive ultrafiltrations during step (III).

24. The method according to claim 22, wherein, in step (III), the ultrafiltration membrane is a ceramic or organic membrane.

25. The method according to claim 24, wherein the ultrafiltration membrane is a combination of at least one organic spiral membrane and at least one organic flat membrane.

26. The method according to claim 25, wherein in step (III), the ultrafiltration(s) of the heated curd is/are performed at the spiral membrane with a pressure of approximately 1.5-3 bars at the inlet and 1-2 bars at the outlet, and at the flat membrane with a pressure of approximately 5-10 bars at the inlet and 0.5-2 bars at the outlet.

27. The method according to claim 22, wherein, in step (III), the ultrafiltration membranes have a weight cut-off (MWCO) of 10-50 kDa.

28. The method according to claim 22, wherein the heat treatment of all or part of the curd after step (II), before step (III), is performed at a temperature of 25-60° C., for a few seconds to 600 seconds.

29. The method according to claim 22, comprising after step Iii) or Iii′) a step of homogenizing the dairy mixture.

30. The method according to claim 22, wherein the homogenization is performed by high pressure or shear phenomena applied to the mixture to be homogenized.

31. The method according to claim 22, wherein the standardization of the dairy mixture (Iiii) or (Iiii′) further comprises an adjustment of content of heat-treated native whey proteins to 0-20% (w/w) relative to the total protein content of said standardized milk.

32. The method according to claim 22, wherein the cooling of the curd in step (IV) is carried out by lowering the temperature to a value of 0-30° C.

33. The method according to claim 22, comprising the steps of
subjecting the part of the curd not heated and not drained by ultrafiltration to a conventional draining;
homogenizing then cooling (IV) the other part of the curd heated and drained by ultrafiltration
bringing together the curds thus drained before molding or salting (V).

34. The method according to claim 33, comprising a step of subjecting the permeate of the conventionally drained curd to an ultrafiltration and a step of subjecting the ultrafiltration retentate resulting therefrom to a heat treatment.

35. The method according to claim 34, comprising recycling the heated ultrafiltration retentate upstream of the method during the standardization (Iiii) or (Iiii′) of the dairy mixture in step (I) of preparing the cheese-making dairy mixture.

36. The method according to claim 22, wherein said dairy mixture is obtained from raw milk or whole goat's, sheep's or cow's milk, said method further comprises the following steps:
(a) pasteurizing the raw milk or whole milk;
(b) skimming the pasteurized milk and recovering the skimmed milk, on the one hand, and cream on the other hand;
c) microfiltrating the skimmed milk and recovering the microfiltration retentate;
the microfiltration retentate recovered in step c) being a dairy fraction of said dairy mixture in step (I).

37. The method according to claim 36, wherein the microfiltration of the skimmed milk c) is carried out on a microfiltration membrane whose average pore diameter is 0.1-10 μm.

38. The method according to claim 36, wherein the heat treatment applied to the microfiltration retentate and to the cream as a mixture (Iii′) or separately (Ii) is carried out at a temperature of 65-120° C. for 30-900 seconds.

39. The method according to claim 36, wherein the heat treatment applied to the microfiltration retentate and to the cream as a mixture (Iii′) or separately (Ii) is carried out at a temperature of 80-95° C. for 50-600 seconds.

40. The method according to claim 36, wherein it comprises the following steps:
d) recovering the microfiltration permeate from step c), ultrafiltrating said permeate and recovering the ultrafiltration retentate,
e) heat treating all or part of said ultrafiltration retentate at a temperature of 65-100° C. for 30-900 seconds, and
f) mixing the heated ultrafiltration retentate with the mixture from step Iii) or the mixture from step Iii′) in steps Iiii) and Iiii′), respectively, to obtain the cheese-making dairy mixture.

41. The method according to claim 40, wherein step e) is performed at 78-90° C. for 30-900 seconds.

42. The method according to claim 40, wherein the content of soluble proteins in the ultrafiltration retentate recovered in step d) is 0-10.0% (w/w) relative to the initial content of soluble proteins of the microfiltered skimmed milk from step c) regardless of the time of year.

43. The method according to claim 40, comprising a step, after step e) and before step f), of homogenizing the heated ultrafiltration retentate under a pressure of 5 to 800 bars.

44. The method according to claim 40, wherein it comprises a step of recovering at least one part of said ultrafiltration retentate f) then a step of drying said ultrafiltration retentate thus recovered for use in human food or complementary feeding.
